(19) United States
(12) Patent Application Publication
(10) Pub. No.: US 2023/0013362 A1
(43) Pub. Date: Jan. 19, 2023

(54) THREE-DIMENSIONAL STRING WOVEN AIR CUSHION AND MANUFACTURING METHOD THEREOF

(71) Applicant: ANSSIL CO., LTD., Gwangju-si (KR)

(72) Inventor: Beom Keun SONG, Suwon-si (KR)

(73) Assignee: ANSSIL CO., LTD., Gwangju-si (KR)

(21) Appl. No.: 17/955,459

(22) Filed: Sep. 28, 2022

Related U.S. Application Data
(63) Continuation of application No. PCT/KR2021/000306, filed on Jan. 11, 2021.

(30) Foreign Application Priority Data
Mar. 31, 2020 (KR) 10-2020-0038951

(51) Int. Cl. A47C 21/04; A47C 31/00; A47C 27/12; D03D 1/00; D03D 9/00

(52) U.S. Cl. CPC A47C 21/046; A47C 27/122; A47C 31/006; D03D 1/0017; D03D 9/00

(57) ABSTRACT

The present invention relates to a three-dimensional string woven air cushion and a method of manufacturing the same, the three-dimensional string woven air cushion including a lower sheet layer made by interlacing a plurality of weft yarns and a plurality of warp yarns and configured to define a predetermined thickness layer and a bottom surface, an upper sheet layer made by interlacing a plurality of weft yarns and a plurality of warp yarns and configured to define a predetermined thickness layer and a top surface, the upper sheet layer being disposed above the lower sheet layer, provided in parallel with the lower sheet layer, and spaced apart from the lower sheet layer at a predetermined distance, and an interval maintaining yarn layer made by interlacing interval maintaining yarns connected to at least one of the weft yarn and the warp yarn of each of the lower and upper sheet layers, the interval maintaining yarns being continuously interlaced and connected in a zigzag manner in a direction from one side to the other side, thereby providing an advantage that greatly improve a user’s sleeping convenience.

### TECHNICAL FIELD

The present invention relates to a three-dimensional string woven air cushion and a method of manufacturing the same, and more particularly, to a three-dimensional string woven air cushion capable of being easily cut to be suitable for sizes and purposes, and a method of manufacturing the same capable of greatly improving productivity during a process of manufacturing a mattress cushion.

### Background Art

In general, because a dual-space woven fabric product is securely manufactured, has strong durability, and is capable of being assembled and disassembled, the dual-space woven fabric product may be stored in any space and conveniently carried. Therefore, the dual-space woven fabric product is mainly used to manufacture boats for leisure, fishing, racing, lifesaving, working, industry, observation, and the like.

FIG. 1 is a schematic view of a dual-space woven fabric product in the related art.

As illustrated in FIG. 1, the dual-space woven fabric product generally includes lower and upper layer raw fabrics

10 and 20, which are configured as woven fabrics, and interval maintaining yarns 30 that are core yarns provided in the lower and upper layer raw fabrics 10 and 20.

Meanwhile, in comparison with plywood in the related art, the dual-space woven fabric product used to manufacture a boat has less damage such as cracks caused by external factors (ultraviolet rays, seawater, a change in temperature, and the like) and does not need a separate connection component used to assemble the plywood. Therefore, the dual-space woven fabric product is excellent in ease of assembly.

Further, because the dual-space woven fabric product has buoyancy itself, the dual-space woven fabric product never sinks in the water. A concave-convex shape of an outer surface of the dual-space woven fabric product implements an embossing effect that prevents slipping even in a wet place.

However, the dual-space woven fabric product in the related art is limited in purposes because the dual-space woven fabric product is manufactured only for manufacturing a boat in the related art. Further, because the entire raw fabric of the dual-space woven fabric product is made by vertically interlacing the interval maintaining yarns 30, there is a problem in that the dual-space woven fabric product requires post-processing for manufacturing the product, such as a process of cutting unnecessary interval maintaining yarns 30 with scissors or knives to cut the dual-space woven fabric product or finish a lateral surface of the dual-space woven fabric product.

Further, as illustrated in FIG. 1, the plurality of interval maintaining yarns 30 is vertically interlaced and connected between the lower layer raw fabric 10 and the upper layer raw fabric 20. For this reason, there is a problem in that the upper layer raw fabric 20 is pushed in one direction when a load of a predetermined weight member such as a user is applied to the dual-space woven fabric product, which causes a deterioration in the user’s sleeping stability.

### Disclosure

### Technical Problem

The present invention has been made in an effort to solve the above-mentioned technical problems, and an object of the present invention is to provide a three-dimensional string woven air cushion, in which interval maintaining yarns are interlaced and connected to define an interval maintaining yarn layer between a lower sheet layer and an upper sheet layer, thereby maintaining a predetermined interval even in case that a predetermined load is applied and providing more comfortable cushioning properties to a user by completely filling the interval maintaining yarn layer with air, and a method of manufacturing the same.

Another object of the present invention is to provide a three-dimensional string woven air cushion, in which interval maintaining yarn layers are interlaced and connected in a zigzag manner between a lower sheet layer and an upper sheet layer by using a punching needle part, thereby preventing eccentric distortion of the upper sheet layer caused by the application of a user’s load, and a method of manufacturing the same.

### Technical Solution

An embodiment of the present invention provides a three-dimensional string woven air cushion including: a lower sheet layer made by interlacing a plurality of weft yarns and a plurality of warp yarns and configured to define a predetermined thickness layer and a bottom surface; an upper sheet layer made by interlacing a plurality of weft yarns and a plurality of warp yarns and configured to define a predetermined thickness layer and a top surface, the upper sheet layer being disposed above the lower sheet layer, provided in parallel with the lower sheet layer, and spaced apart from the lower sheet layer at a predetermined distance; and an interval maintaining yarn layer made by interlacing interval maintaining yarns connected to at least one of the weft yarn and the warp yarn of each of the lower and upper sheet layers, the interval maintaining yarns being continuously interlaced and connected in a zigzag manner in a direction from one side to the other side.

In this case, the interval maintaining yarn layer may include cutting portions intermittently spaced apart from one another.

In addition, the interval maintaining yarn layer may be woven by the interval maintaining yarns sewn on a punching needle part disposed above the upper sheet layer or below the lower sheet layer and configured to penetrate the upper sheet layer and the lower sheet layer simultaneously.

In addition, the interval maintaining yarn layer may be woven as the punching needle part moves horizontally in the direction from one side to the other side while reciprocating vertically.

In addition, the interval maintaining yarn layer may be woven as the punching needle part reciprocates vertically while the lower sheet layer and the upper sheet layer move horizontally.

In addition, the interval maintaining yarn layer may be woven by the punching needle part including: a movable unit disposed outside the lower sheet layer or the upper sheet layer and configured to move horizontally or reciprocate vertically; and a plurality of weaving needles extending perpendicularly to the movable unit in a thickness direction of the interval maintaining yarn layer and configured such that the interval maintaining yarns are sewn on the plurality of weaving needles.

The lower and upper sheet layers may each further include a stack part stacked by coating in at least one layer on an outer surface of the thickness layer, and the stack part may include: a PVC coating layer formed by coating on an outer surface of the thickness layer; a PVC sheet stacked in at least one layer on an outer surface of the PVC coating layer; and an EF polymer layer stacked on an outer surface of the PVC sheet.

In addition, the PVC coating layer may be provided in the form of a liquid, inputted into the thickness layer, and then cured.

Another embodiment of the present invention provides a method of manufacturing a three-dimensional string woven air cushion, the method including: a sheet layer preparation process of preparing lower and upper sheet layers each having a predetermined thickness layer and made by interlacing a plurality of weft yarns and a plurality of warp yarns; and an interval maintaining yarn interlacing process of forming an interval maintaining yarn layer, after the sheet layer preparation process, by interlacing and connecting a plurality of interval maintaining yarns between the lower sheet layer and the upper sheet layer in a zigzag manner in a direction from one side to the other side by using a punching needle part.

In this case, the interval maintaining yarn interlacing process may be a process in which the interval maintaining yarn layer is woven as the punching needle part moves horizontally in the direction from one side to the other side while reciprocating vertically.

In addition, the interval maintaining yarn interlacing process may be a process in which the interval maintaining yarn layer is woven as the punching needle part reciprocates vertically while the lower sheet layer and the upper sheet layer move horizontally.

In addition, the interval maintaining yarn interlacing process may be a process in which the interval maintaining yarns are interlaced with and connected to at least one of the weft yarn and the warp yarn of each of the lower and upper sheet layers by the punching needle part.

In addition, the method may further include: a stack part forming process of, after the interval maintaining yarn interlacing process, forming stack parts by stacking the stack parts in one or more layers by coating outside the lower and upper sheet layers.

In addition, the stack part forming process may be a process of coating an outer surface of the thickness layer with PVC, stacking a PVC sheet in at least one layer, and then stacking an EF polymer on an outer surface of the PVC sheet.

### Advantageous Effects

The three-dimensional string woven air cushion and the method of manufacturing the same according to the embodiment of the present invention may achieve the following various effects.

First, the interval maintaining yarn layer is provided between the lower sheet layer and the upper sheet layer, which makes it possible to maintain the predetermined interval and provide more comfortable cushioning properties to the user by completely filling the interval maintaining yarn layer with air.

Second, the interval maintaining yarns, which serve as a kind of filling material, are interlaced and connected in a zigzag manner between the lower sheet layer and the upper sheet layer, which makes it possible to perfectly prevent the eccentric distortion of the upper sheet layer even though the user’s load is applied, thereby improving the functionality and external aesthetic appearance.

Third, the cutting portion, in which no interval maintaining yarn layer is disposed, is provided to manufacture the single raw fabric including the lower sheet layer and the upper sheet layer, which makes it easy to perform the cutting process.

### DESCRIPTION OF DRAWINGS

FIG. 1 is a schematic view illustrating an example of a three-dimensional string weaving method in the related art.

FIG. 2 is a perspective view illustrating an embodiment of a three-dimensional string woven air cushion according to the present invention.

FIG. 3 is a schematic view illustrating the inside of FIG. 2.

FIG. 4 is a perspective view illustrating an inner shape of the woven air cushion woven by a lower sheet layer, an upper sheet layer, and vertical yarns among components in FIG. 2.

FIG. 5 is a schematic view illustrating a method of manufacturing the three-dimensional string woven air cushion according to the present invention.

FIG. 6 is a top plan view and a side view of the woven air cushion manufactured by the method in FIG. 5.

FIG. 7 is a top plan view and a side view of the woven air cushion cut by the method in FIG. 6.

### EXPLANATION OF REFERENCE NUMERALS AND SYMBOLS

101: Detachable mattress cover

103: Upper cushioning material

105: Woven air cushion

110: Lower sheet layer

111: Weft yarn

112: Warp yarn

113: Stack part

120: Upper sheet layer

121: Weft yarn

122: Warp yarn

123: Stack part

130: Interval maintaining yarn layer

150: Punching needle part

151: Movable unit

153: Plurality of weaving needles

210: Essential portion

220: Cutting portion

### Best Mode

Hereinafter, embodiments of a three-dimensional string woven air cushion and a method of manufacturing the same according to the present invention will be described in detail with reference to the accompanying drawings.

In giving reference numerals to constituent elements of the respective drawings, it should be noted that the same constituent elements will be designated by the same reference numerals, if possible, even though the constituent elements are illustrated in different drawings. Further, in the following description of the embodiments of the present invention, a detailed description of related publicly-known configurations or functions will be omitted when it is determined that the detailed description obscures the understanding of the embodiments of the present invention.

In addition, the terms first, second, A, B, (a), and (b) may be used to describe constituent elements of the embodiments of the present invention. These terms are used only for the purpose of discriminating one constituent element from another constituent element, and the nature, the sequences, or the orders of the constituent elements are not limited by the terms. Further, unless otherwise defined, all terms used herein, including technical or scientific terms, have the same meaning as commonly understood by those skilled in the art to which the present invention pertains. The terms such as those defined in commonly used dictionaries should be interpreted as having meanings consistent with meanings in the context of related technologies and should not be interpreted as ideal or excessively formal meanings unless explicitly defined in the present application.

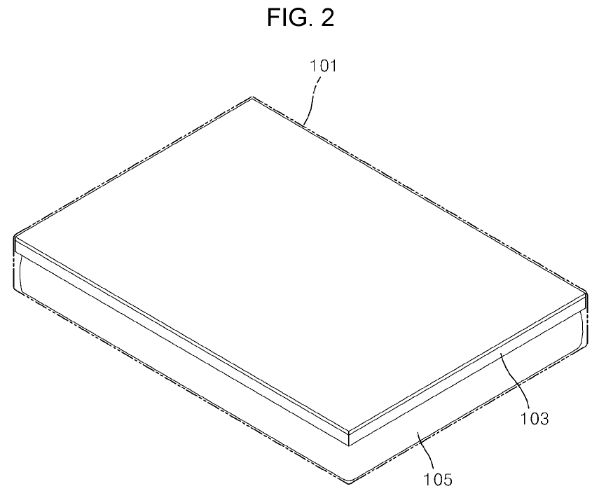

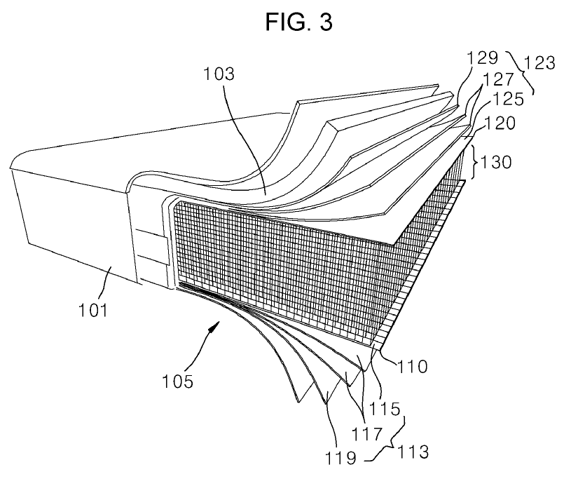

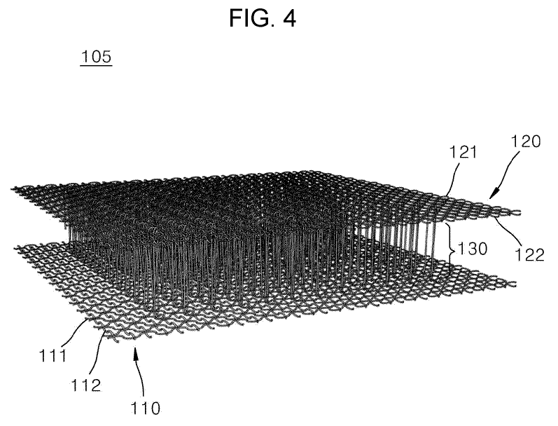

FIG. 2 is a perspective view illustrating an embodiment of a three-dimensional string woven air cushion according to the present invention, FIG. 3 is a schematic view illustrating the inside of FIG. 2, and FIG. 4 is a perspective view illustrating an inner shape of the woven air cushion woven by a lower sheet layer, an upper sheet layer, and vertical yarns among components in FIG. 2.

As illustrated in FIGS. 2 to 4, an embodiment of a three-dimensional string woven air cushion 105 according to the present invention includes a lower sheet layer 110 configured to define a bottom surface, an upper sheet layer 120 configured to define a top surface, and interval maintaining yarn layers 130 interlaced between the lower sheet layer 110 and the upper sheet layer 120.

As illustrated in FIG. 4, the lower sheet layer 110 is a predetermined thickness layer formed by interlacing a plurality of weft yarns 111 and a plurality of warp yarns 112. Interval maintaining yarns of the interval maintaining yarn layer 130 to be described below may be interlaced and extend toward the upper sheet layer 120.

As illustrated in FIG. 4, the upper sheet layer 120 is made by interlacing a plurality of weft yarns 121 and a plurality of warp yarns 122 and configured to define a predetermined thickness layer. The interval maintaining yarns of the interval maintaining yarn layer 130 to be described below may be interlaced and extend toward the lower sheet layer 110.

Meanwhile, in the embodiment of the three-dimensional string woven air cushion 105 according to the present invention, as illustrated in FIG. 3, the lower and upper sheet layers 110 and 120 may further include stack parts 113 and 123, respectively, and the stack part is stacked by coating in at least one layer on an outer surface of the thickness layer.

As illustrated in FIG. 3, the stack part 113 or 123 may include: a PVC coating layer 115 or 125 formed by coating on the outer surface of the thickness layer of each of the lower and upper sheet layers 110 and 120; a PVC sheet 117 or 127 stacked in at least one layer (two layers in the embodiment of the present invention) on an outer surface of the PVC coating layer 115 or 125; and an EF polymer layer 119 or 129 stacked on an outer surface of the PVC sheet 117 or 127.

The PVC coating layer 115 or 125 is made by inputting a liquid into the thickness layer, which is made by interlacing the plurality of warp yarns 111 or 121 and the plurality of weft yarns 112 or 122, and then curing the liquid. The PVC coating layer 115 or 125 may serve to completely separate and block the inside and outside thereby preventing air from leaking to the outside in case that the inside is filled with air by a non-illustrated air filling part to be described below.

Further, the PVC sheet 117 or 127 and the EF polymer layer 119 or 129 serve to define a plurality of film coating layers and ensure strength and stability, such that children and old and weak persons may safely use the PVC sheet 117 or 127 and the EF polymer layer 119 or 129 in homes or public places.

In addition, the stack part 113 or 123 has predetermined strength and thus serves to define a stable external shape of the three-dimensional string woven air cushion 105 according to the embodiment of the present invention in case that the inside of the three-dimensional string woven air cushion 105 is completely filled with air by the air filling part to be described below.

The stack part 113 or 123 may be formed after the interval maintaining yarn layer 130 is formed between the lower sheet layer 110 and the upper sheet layer 120. Only some layers may be formed in advance by coating so that the interval maintaining yarns, which constitute the interval maintaining yarn layer 130, are easily interlaced.

Meanwhile, the three-dimensional string woven air cushion 105 according to the embodiment of the present invention may singly serve as a mattress on which a user takes a sleep or rest. However, because the user’s skin comes into direct contact with the three-dimensional string woven air cushion 105, the three-dimensional string woven air cushion 105 may further include a detachable mattress cover 101 and an upper cushioning material 103 stacked on an upper portion of the upper sheet layer 120, as illustrated in FIGS. 2 and 3.

The detachable mattress cover 101 may have a fillable structure that separates and partitions the upper sheet layer 120 and the upper cushioning material 103 of the three-dimensional string woven air cushion 105 according to the embodiment of the present invention including the lower sheet layer 110, the upper sheet layer 120, and the interval maintaining yarn layer 130.

The upper cushioning material 103 may be a cushioning material provided in the form of general foam manufactured by a manufacturing method different from a method of manufacturing the three-dimensional string woven air cushion according to the present invention. However, the upper cushioning material 103 need not be necessarily provided separately from the three-dimensional string woven air cushion. The upper cushioning material 103 may serve as an auxiliary cushion, which provides auxiliary cushioning properties, in addition to cushioning properties of the interval maintaining yarn layer 130 provided between the lower sheet layer 110 and the upper sheet layer 120 and cushioning properties of filling air made by the air filling part to be described below.

The detachable mattress cover 101 may have an opening/closing part (not illustrated) provided in the form of a zipper so that the three-dimensional string woven air cushion 105 and the upper cushioning material 103 according to the embodiment of the present invention are easily replaced and separated.

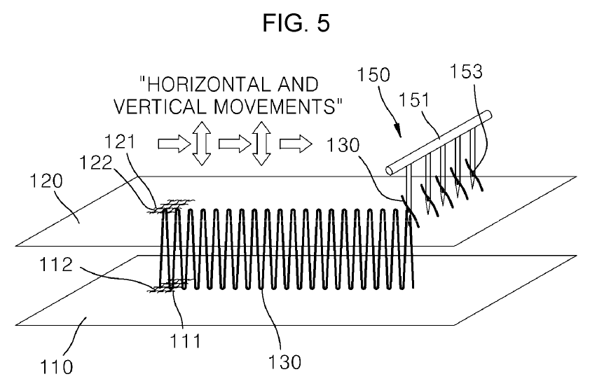

FIG. 5 is a schematic view illustrating a method of manufacturing the three-dimensional string woven air cushion according to the present invention.

As illustrated in FIG. 5, the three-dimensional string woven air cushion 105 according to the embodiment of the present invention includes the interval maintaining yarn layer 130 woven between the lower sheet layer 110 and the upper sheet layer 120.

The interval maintaining yarn layer 130 is provided between the lower sheet layer 110 and the upper sheet layer 120 by interlacing the plurality of interval maintaining yarns having their own predetermined volume. The predetermined volume serves to maintain a predetermined distance between the lower sheet layer 110 and the upper sheet layer 120. Further, in case that the three-dimensional string woven air cushion is filled with air by the air filling part to be described below, an expansion pressure of the air serves to maintain a longer spacing distance between the lower sheet layer 110 and the upper sheet layer 120 in addition to the above-mentioned predetermined distance.

In this case, the interval maintaining yarn may be interlaced with at least one of the weft yarn 111 or 121 and the warp yarn 112 or 122 of the lower sheet layer 110 and the upper sheet layer 120. The interval maintaining yarns may be continuously interlaced and connected in a zigzag manner in a direction from one side to the other side.

For example, as illustrated in FIG. 5, in case that the interval maintaining yarn is initially interlaced with and connected to any one of the weft yarn 111 and the warp yarn 112 of the lower sheet layer 110, the interval maintaining yarn may extend toward the upper sheet layer 120 at the upper side inclined upward at a predetermined angle in a direction from one side to the other side and be interlaced with and connected to any one of the weft yarn 121 and the warp yarn 122 of the upper sheet layer 120, and then the interval maintaining yarn may be interlaced with any one of the weft yarn 111 and the warp yarn 112 of the lower sheet layer 120 at the lower side inclined downward at a predetermined angle in the direction from one side to the other side. Therefore, the interval maintaining yarn may be continuously interlaced and connected in a zigzag manner.

Particularly, the interval maintaining yarns, which constitute the interval maintaining yarn layer 130, may be connected to the upper sheet layer 120 to be inclined at a predetermined angle toward each of one side and the other side based on a woven portion of the lower sheet layer 110.

In case that the interval maintaining yarns are interlaced to be inclined at a predetermined angle toward each of one side and the other side, the upper sheet layer 120 does not eccentrically move toward one side and the other side when the user’s load is applied, as described below, and the upper sheet layer 120 is deformed in shape in a direction of the user’s load without change, which makes it possible to provide an advantage capable of improving the user’s sleeping stability.

The above-mentioned configuration in which the interval maintaining yarns are interlaced with and connected to the lower sheet layer 110 and the upper sheet layer 120 may be implemented by a punching needle part 150 as illustrated in FIG. 5.

More specifically, the punching needle part 150 may include: a movable unit 151 provided to be able to horizontally move or vertically reciprocate outside the lower sheet layer 110 or the upper sheet layer 120; and a plurality of weaving needles 153 extending perpendicularly to the movable unit 151 in a thickness direction of the interval maintaining yarn layer 130 and configured to interlace the interval maintaining yarns.

The embodiment of the present invention has been restrictively described in which the single punching needle part 150 is provided outside the lower sheet layer 110 or the upper sheet layer 120. However, two punching needle parts 150 may be provided such that one punching needle part 150 is disposed below the lower sheet layer 110, and the other punching needle part 150 is disposed above the upper sheet layer 120 to more densely interlace the interval maintaining yarns. The two punching needle parts 150 may simultaneously interlace the interval maintaining yarns in the same direction.

When the movable unit 151, which is one of the components of the punching needle part 150, vertically reciprocates, the movable unit 151 may reciprocate vertically without coming into contact with the outer surface of the sheet layer 110 or 120, i.e., the lower sheet layer 110 or the upper sheet layer 120, which is adjacent to the movable unit 151.

Further, among the components of the punching needle part 150, a length of each of the plurality of weaving needles 153 may be at least larger than a thickness of the interval maintaining yarn layer 130 between the lower sheet layer 110 and the upper sheet layer 120. Therefore, when the movable unit 151 reciprocates vertically, the plurality of weaving needles 153 may penetrate the upper sheet layer 120 or the lower sheet layer 110, which is adjacent to the plurality of weaving needles 153, in a state in which the interval maintaining yarns are sewn on ends of the plurality of weaving needles 153, and then the plurality of weaving needles 153 may penetrate the lower sheet layer 110 or the upper sheet layer 120, which is opposite to the upper sheet layer 120 or the lower sheet layer 110, such that the interval maintaining yarns are continuously interlaced in a zigzag manner by a process of repeatedly interlacing the interval maintaining yarn with any one of the weft yarn 111 or 121 and the warp yarn 112 or 122.

The plurality of interval maintaining yarns, which is supplied to penetrate the upper sheet layer 120 or supplied to penetrate the lower sheet layer 110 by the plurality of weaving needles 153, may be interlaced with at least any one of the weft yarn 111 or 121 or the warp yarn 112 or 122 of the opposite sheet layer (e.g., the lower sheet layer 110 when the plurality of interval maintaining yarns is supplied to penetrate the upper sheet layer 120 or the upper sheet layer 120 when the plurality of interval maintaining yarns is supplied to penetrate the lower sheet layer 120).

Therefore, the interval maintaining yarn layer 130 may be defined as a layer continuously woven and connected in a zigzag manner between the lower sheet layer 110 and the upper sheet layer 120 by the punching needle part 150.

Further, as illustrated in FIG. 5, the interval maintaining yarn layer 130 may be defined as a layer woven by the punching needle part 150 that reciprocates vertically and repeatedly move horizontally in the direction from one side to the other side. That is, the interval maintaining yarn layer 130 is woven by operating the punching needle part 150 so that only the punching needle part 150 reciprocates vertically and repeatedly moves horizontally in the state in which the lower sheet layer 110 and the upper sheet layer 120 are fixed to be spaced apart from each other at a predetermined interval.

However, the interval maintaining yarn layer 130 need not be necessarily defined as a layer woven by the above-mentioned weaving method. Although not illustrated in the drawings, the interval maintaining yarn layer 130 may be defined as a layer made by interlacing the interval maintaining yarns by reciprocating the punching needle part 150 vertically when the lower sheet layer 110 and the upper sheet layer 120 move horizontally in the state in which the lower sheet layer 110 and the upper sheet layer 120 are fixed to be spaced apart upward and downward from each other at a predetermined distance. In this case, the lower sheet layer 110 and the upper sheet layer 120 may move horizontally in a direction opposite to the weaving direction.

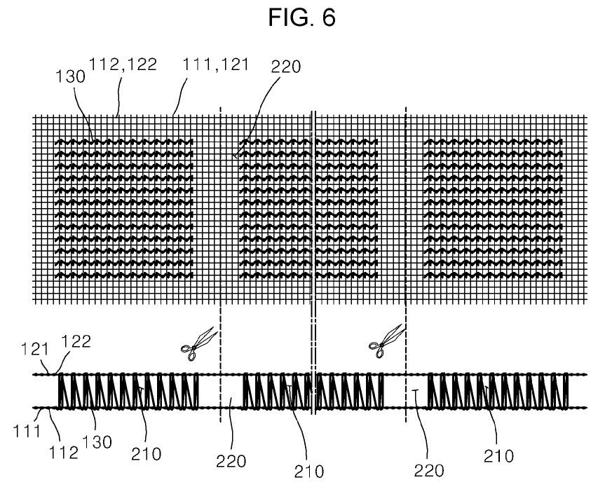

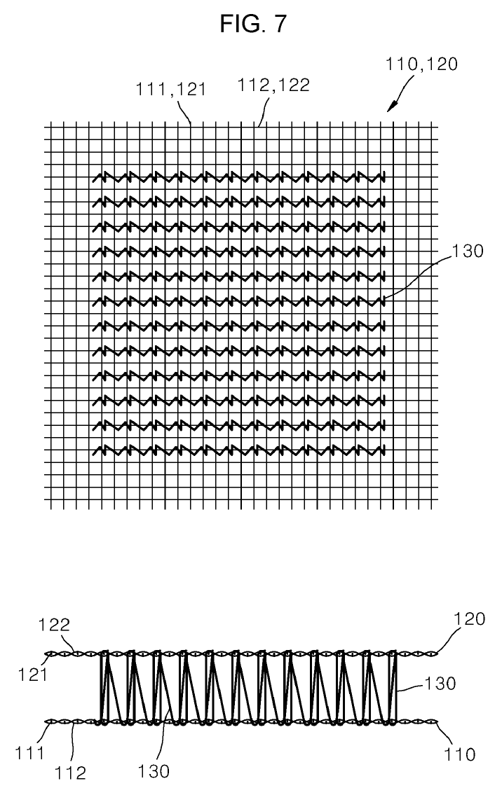

FIG. 6 is a top plan view and a side view of the woven air cushion manufactured by the method in FIG. 5, and FIG. 7 is a top plan view and a side view of the woven air cushion cut by the method in FIG. 6.

As illustrated in FIG. 6, in the three-dimensional string woven air cushion 105 according to the embodiment of the present invention, a raw fabric initially constituting the lower sheet layer 110 and a raw fabric initially constituting the upper sheet layer 120 need to be cut into a predetermined size used for a final product. In this case, in case that the interval maintaining yarns of the interval maintaining yarn layer 130 provided in the space between the lower sheet layer 110 and the upper sheet layer 120 are cut, a process of finishing the ends of the interval maintaining yarns needs to be performed, which causes inconvenience.

The three-dimensional string woven air cushion 105 according to the embodiment of the present invention may further include a cutting portion 220 made by intermittently spacing the interval maintaining yarn layers 130 at a distance to simplify the finishing process. The cutting portion 220 is a portion where the interval maintaining yarn layer 130 is not formed intermittently at the initial time so that the interval maintaining yarns included in the interval maintaining yarn layer 130 are not cut when the raw fabric is cut into a specification size of a product.

More specifically, as illustrated in FIG. 6, in case that a portion made by interlacing the interval maintaining yarns and filled with air to define a space of an actual product is defined as an essential portion 210 and the remaining portion only required for the finishing process is defined as the cutting portion 220, the weaving process performed by the punching needle part 150 may be partially stopped to define the cutting portion 220.

Because the cutting portion 220 is a section in which the interval maintaining yarn layers 130 are intermittently eliminated, the interval maintaining yarns are not cut in case that the raw fabric is cut by using the cutting portion 220. Therefore, because only the cut portions of the weft yarn 111 and the warp yarn 112 of the lower sheet layer 110 and the weft yarn 121 and the warp yarn 122 of the upper sheet layer 120 may be finished, the finishing process is much simplified. Further, as illustrated in FIG. 7, it is possible to produce the completely manufactured three-dimensional string woven air cushion 105 according to the embodiment of the present invention.

Meanwhile, in the three-dimensional string woven air cushion 105 according to the embodiment of the present invention, the interval maintaining yarn layer 130 may be provided by continuously interlacing the interval maintaining yarns in a zigzag manner. Therefore, the three-dimensional string woven air cushion 105 is deformed in shape immediately downward even when the user applies a predetermined load through the upper sheet layer 120, which makes it possible to prevent the upper sheet layer 120 from being eccentrically distorted toward one side. Therefore, the user may take a rest or sleep on the upper portion of the upper sheet layer 120 while receiving stable cushioning properties.

A method of manufacturing the three-dimensional string woven air cushion according to the embodiment of the present invention configured as described above will be briefly described.

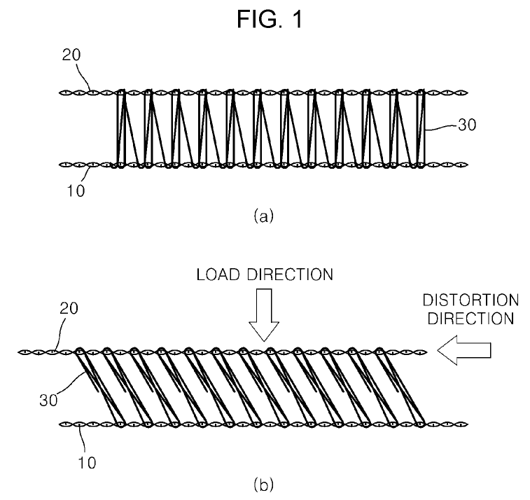

As illustrated in FIGS. 1 to 7, the method of manufacturing the three-dimensional string woven air cushion according to the embodiment of the present invention includes: a sheet layer preparation process of preparing the lower and upper sheet layers 110 and 120 each having the predetermined thickness layer and made by interlacing the plurality of weft yarns 111 and 121 and the plurality of warp yarns 112 and 122; and an interval maintaining yarn interlacing process of forming the interval maintaining yarn layer 130, after the sheet layer preparation process, by interlacing and connecting the plurality of interval maintaining yarns between the lower sheet layer 110 and the upper sheet layer 120 in a zigzag manner in a direction from one side to the other side by using the punching needle part 150.

Further, the method of manufacturing the three-dimensional string woven air cushion according to the embodiment of the present invention may further include a stack part forming process of forming the stack parts 113 and 123, after the interval maintaining yarn interlacing process, by stacking the stack parts 113 and 123 in one or more layers by coating outside the lower and upper sheet layers 110 and 120.

In this case, the stack part forming process may be defined as a process of forming the PVC coating layers 115 and 125 by coating the outer surfaces of the thickness layers of the lower and upper sheet layers 110 and 120 with PVC, stacking each of the PVC sheets 117 and 127 in at least one layer, and then forming the EF polymer layers 119 and 129 by stacking EF polymers on the respective outer surfaces of the PVC sheets 117 and 127.

A part of the stack part 113 or 123 (particularly, the PVC coating layer 115 or 125) may be provided in the form of a liquid and applied into an interlaced portion of the interval maintaining yarns of the lower sheet layer 110 and an interlaced portion of the interval maintaining yarns of the upper sheet layer 120 and then be cured, thereby sealing the lower and upper sheet layers 110 and 120 so that the interval maintaining yarn layer 130 is filled with air without an air leak to the outside.

Meanwhile, as illustrated in FIG. 5, the interval maintaining yarn interlacing process may be defined as a process in which the interval maintaining yarns are interlaced by the punching needle part 150 that reciprocates vertically and moves horizontally in the direction from one side to the other side.

However, the interval maintaining yarn interlacing process need not be necessarily defined as illustrated in FIG. 5. Although not illustrated in the drawings, the interval maintaining yarn interlacing process may be defined as a process in which the interval maintaining yarns are interlaced as the punching needle part 150 reciprocates vertically while the lower sheet layer 110 and the upper sheet layer 120 move horizontally.

In addition, the interval maintaining yarn interlacing process may be a process in which the interval maintaining yarn is interlaced with and connected to at least one of the weft yarns 111 and 121 and the warp yarn 112 and 122 of the lower and upper sheet layers 110 and 120 by the punching needle part 150.

The interval maintaining yarn layer 130 made by the above-mentioned process is completely filled with air injected by the non-illustrated air filling part, such that the volume of the interval maintaining yarns serves to ensure a minimum interval between the lower sheet layer 110 and the upper sheet layer 120. Further, one end of the interval maintaining yarn is interlaced with and connected to the lower sheet layer 110, and the other end of the interval maintaining yarn is interlaced with and connected to the upper sheet layer 120, which serves to restrict a maximum spacing distance between the lower sheet layer 110 and the upper sheet layer 120 when the interval maintaining yarn layer 130 is completely filled with air by the air filling part.

More specifically, the interval maintaining yarn may be a core yarn that may maintain an interval between the lower sheet layer 110 and the upper sheet layer 120 as an approximately 50 to 500 mm. Therefore, the interval between the lower sheet layer 110 and the upper sheet layer 120 may be maintained as minimum 50 mm by the volume of the interval maintaining yarns even before the air filling part injects air. After the air filling part injects air, the interlaced connection portions at two opposite ends may prevent the maximum spacing distance between the lower sheet layer 110 and the upper sheet layer 120 from exceeding 500 mm.

In addition, the interval maintaining yarns may be continuously interlaced and connected in a zigzag manner in an interlacing direction between the lower sheet layer 110 and the upper sheet layer 120 by the punching needle part 150. Therefore, the upper sheet layer 110 may be deformed in shape in a direction corresponding to a direction in which a load is applied by the user, such that more stable cushioning properties may be provided to the user.

The embodiments of the three-dimensional string woven air cushion and the method of manufacturing the same according to the present invention have been described above in detail with reference to the accompanying drawings. However, the present invention is not necessarily limited by the embodiments, and various modifications of the embodiments and any other embodiments equivalent thereto may of course be carried out by those skilled in the art to which the present invention pertains. Accordingly, the true protection scope of the present invention should be determined by the appended claims.

### Industrial Applicability

The present invention provides the three-dimensional string woven air cushion, in which the interval maintaining yarns are interlaced and connected to define the interval maintaining yarn layer between the lower sheet layer and the upper sheet layer, thereby maintaining a predetermined interval even in case that a predetermined load is applied and providing more comfortable cushioning properties to the user by completely filling the interval maintaining yarn layer with air, and a method of manufacturing the same.

1. A three-dimensional string woven air cushion comprising:
a lower sheet layer made by interlacing a plurality of weft yarns and a plurality of warp yarns and configured to define a predetermined thickness layer and a bottom surface;
an upper sheet layer made by interlacing a plurality of weft yarns and a plurality of warp yarns and configured to define a predetermined thickness layer and a top surface, the upper sheet layer being disposed above the lower sheet layer, provided in parallel with the lower sheet layer, and spaced apart from the lower sheet layer at a predetermined distance; and
an interval maintaining yarn layer made by interlacing interval maintaining yarns connected to at least one of the weft yarn and the warp yarn of each of the lower and upper sheet layers, the interval maintaining yarns being continuously interlaced and connected in a zigzag manner in a direction from one side to the other side.

2. The three-dimensional string woven air cushion of claim 1, wherein the interval maintaining yarn layer comprises cutting portions intermittently spaced apart from one another.

3. The three-dimensional string woven air cushion of claim 1, wherein the interval maintaining yarn layer is woven by the interval maintaining yarns sewn on a punching needle part disposed above the upper sheet layer or below the lower sheet layer and configured to penetrate the upper sheet layer and the lower sheet layer simultaneously.

4. The three-dimensional string woven air cushion of claim 3, wherein the interval maintaining yarn layer is woven as the punching needle part moves horizontally in the direction from one side to the other side while reciprocating vertically.

5. The three-dimensional string woven air cushion of claim 3, wherein the interval maintaining yarn layer is woven as the punching needle part reciprocates vertically while the lower sheet layer and the upper sheet layer move horizontally.

6. The three-dimensional string woven air cushion of claim 3, wherein the interval maintaining yarn layer is woven by the punching needle part comprising:
a movable unit disposed outside the lower sheet layer or the upper sheet layer and configured to be able to move horizontally or reciprocate vertically; and
a plurality of weaving needles extending perpendicularly to the movable unit in a thickness direction of the interval maintaining yarn layer and configured such that the interval maintaining yarns are sewn on the plurality of weaving needles.

7. The three-dimensional string woven air cushion of claim 1, wherein the lower and upper sheet layers each further comprise a stack part stacked by coating in at least one layer on an outer surface of the thickness layer, and
wherein the stack part comprises:
a PVC coating layer formed by coating on an outer surface of the thickness layer;
a PVC sheet stacked in at least one layer on an outer surface of the PVC coating layer; and
an EF polymer layer stacked on an outer surface of the PVC sheet.

8. The three-dimensional string woven air cushion of claim 7, wherein the PVC coating layer is provided in the form of a liquid, inputted into the thickness layer, and then cured.

9. A method of manufacturing a three-dimensional string woven air cushion, the method comprising:
a sheet layer preparation process of preparing lower and upper sheet layers each having a predetermined thickness layer and made by interlacing a plurality of weft yarns and a plurality of warp yarns; and
an interval maintaining yarn interlacing process of forming an interval maintaining yarn layer, after the sheet layer preparation process, by interlacing and connecting a plurality of interval maintaining yarns between the lower sheet layer and the upper sheet layer in a zigzag manner in a direction from one side to the other side by using a punching needle part.

10. The method of claim 9, wherein the interval maintaining yarn interlacing process is a process in which the interval maintaining yarn layer is woven as the punching needle part moves horizontally in the direction from one side to the other side while reciprocating vertically.

11. The method of claim 9, wherein the interval maintaining yarn interlacing process is a process in which the interval maintaining yarn layer is woven as the punching needle part reciprocates vertically while the lower sheet layer and the upper sheet layer move horizontally.

12. The method of claim 9, wherein the interval maintaining yarn interlacing process is a process in which the interval maintaining yarns are interlaced with and connected to at least one of the weft yarn and the warp yarn of each of the lower and upper sheet layers by the punching needle part.

13. The method of claim 9, further comprising:
a stack part forming process of forming stack parts, after the interval maintaining yarn interlacing process, by stacking the stack parts in one or more layers by coating outside the lower and upper sheet layers.

14. The method of claim 13, wherein the stack part forming process is a process of coating an outer surface of the thickness layer with PVC, stacking a PVC sheet in at least one layer, and then stacking an EF polymer on an outer surface of the PVC sheet.
